(19) United States
(12) Patent Application Publication
(10) Pub. No.: US 2019/0064473 A1
(43) Pub. Date: Feb. 28, 2019

(54) LENS BARREL AND IMAGING APPARATUS

(71) Applicant: CANON KABUSHIKI KAISHA, Tokyo (JP)

(72) Inventor: Kei Suzuki, Chigasaki-shi (JP)

(21) Appl. No.: 16/105,212

(22) Filed: Aug. 20, 2018

(30) Foreign Application Priority Data
Aug. 25, 2017 (JP) 2017-161710

(51) Int. Cl. G02B 7/04; G03B 5/00

(52) U.S. Cl. CPC G02B 7/04; H04N 5/2254; G03B 5/00

(57) ABSTRACT

A lens barrel includes a cam cylinder rotatable around an axis parallel to an optical axis of a lens unit, the cam cylinder having a first cam groove and a second cam groove, a lens holding frame that includes a first cam follower engaged with the first cam groove, a moving member that includes a second cam follower engaged with the second cam groove, a forcing member configured to apply a force the first lens holding frame and the moving member in different directions in an optical axis direction. The first cam groove and the second cam groove are formed so as to cancel out a rotating force of the cam cylinder caused by the force of the forcing member.

### BACKGROUND OF THE INVENTION

### Field of the Invention

The present invention relates to an imaging apparatus having a lens barrel configured to hold a lens unit movable back and forth in an optical axis direction.

### Description of the Related Art

In some conventional imaging apparatuses, a camera unit that captures an image of an object is rotatably around a panning axis and a tilt axis and covered with a dome housing etc. Therefore, these imaging apparatuses can capture the image of the object by changing the orientation of the camera unit to an image capturing direction desired by a user. These imaging apparatuses are demanded for a high performance and a small profile of the camera unit, but a high-performance scheme of an imaging lens, such as a high zooming magnification and a larger image sensor, would cause the optical path length in the imaging lens to be long. As a result, the entire imaging apparatus that includes the camera unit and the housing that covers the camera unit becomes larger, and the imaging apparatus cannot be made small. Accordingly, for the high-performance and small imaging lens, one known imaging apparatus linearly moves a plurality of lens units in the optical axis direction through a cam cylinder for zooming. This imaging apparatus needs to reduce the backlash (looseness or unsteadiness) as few as possible in the optical axis direction which can otherwise occur between the cam cylinder and the lens unit.

For example, Japanese Patent Laid-Open No. (“JP”) 2013-254050 discloses a lens barrel that applies a separating or attracting force between moving members that are movable in an optical axis direction via cam followers that are engaged with different cam grooves and do not overlap each other in an actual effective range for their actual movements in the optical axis direction. JP 2003-43331 discloses a lens barrel that includes a plurality of cam grooves engaged with a plurality of cam followers, wherein the two cam followers are provided with the same radial angle at different positions in the optical axis direction, and are forced to be separated in the optical axis direction. According to the lens barrel disclosed in JP 2003-43331, the cam groove corresponding to the object side cam follower is formed wider than the object side cam follower. However, the force influences a torque necessary to rotate the cam cylinder in the lens barrels disclosed in JP 2013-254050 and JP 2003-43331. Since the torque necessary to rotate the cam member increases with the force, it is necessary to make large the driver or to reduce the speed with a gear etc., and the lens barrel becomes larger. As a result, it is difficult to provide a high-performance camera unit inside the dome housing etc.

### SUMMARY OF THE INVENTION

The present invention provides a small and high-performance lens barrel and an imaging apparatus.

A lens barrel according to one aspect of the present invention includes a cam cylinder rotatable around an axis parallel to an optical axis in a lens unit, the cam cylinder having a first cam groove and a second cam groove, a lens holding frame that includes a first cam follower engaged with the first cam groove, a moving member that includes a second cam follower engaged with the second cam groove; and a forcing member configured to apply a force to the first lens holding frame and the moving member in directions different from each other in an optical axis direction. The first cam groove and the second cam groove are formed so as to cancel out a rotating force of the cam cylinder caused by the force applied by the forcing member.

An imaging apparatus according to one aspect of the present invention includes the above lens barrel, and an image sensor configured to photoelectrically convert an optical image formed by the lens barrel.

Further features of the present invention will become apparent from the following description of exemplary embodiments with reference to the attached drawings.

### BRIEF DESCRIPTION OF THE DRAWINGS

FIG. 1 is a perspective view of an imaging apparatus according to this embodiment.

FIG. 2 is a sectional view of the imaging apparatus according to this embodiment.

FIG. 3 is an exploded perspective view of the imaging apparatus according to this embodiment.

FIG. 4 is a perspective view of a fourth barrel, a moving member, and a forcing member according to this embodiment.

FIG. 5 is a sectional view of the fourth barrel, the moving member, and the forcing member according to this embodiment.

FIG. 6 is a developed view illustrating a cam groove in a cam cylinder according to this embodiment.

FIG. 7 is an exploded perspective view of an optical filter driving mechanism according to this embodiment.

FIG. 8 is a sectional view of the imaging apparatus according to this embodiment.

FIG. 9 is a sectional view of a surveillance camera that includes the imaging apparatus according to this embodiment.

FIG. 10 schematically illustrates a forcing direction by a forcing member according to this embodiment.

### DESCRIPTION OF THE EMBODIMENTS

Referring now to the accompanying drawings, a description will be given of embodiments of the present invention.

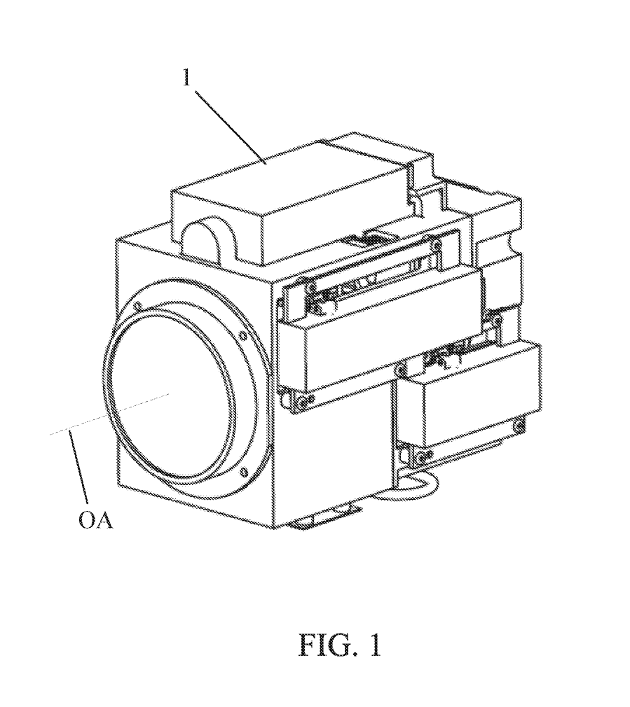

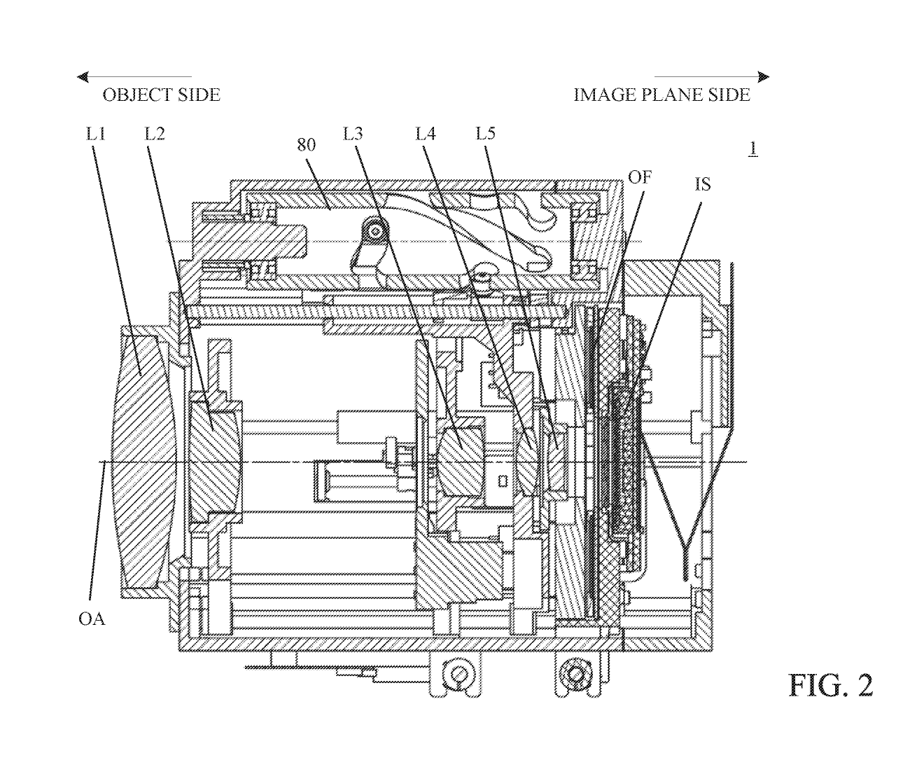

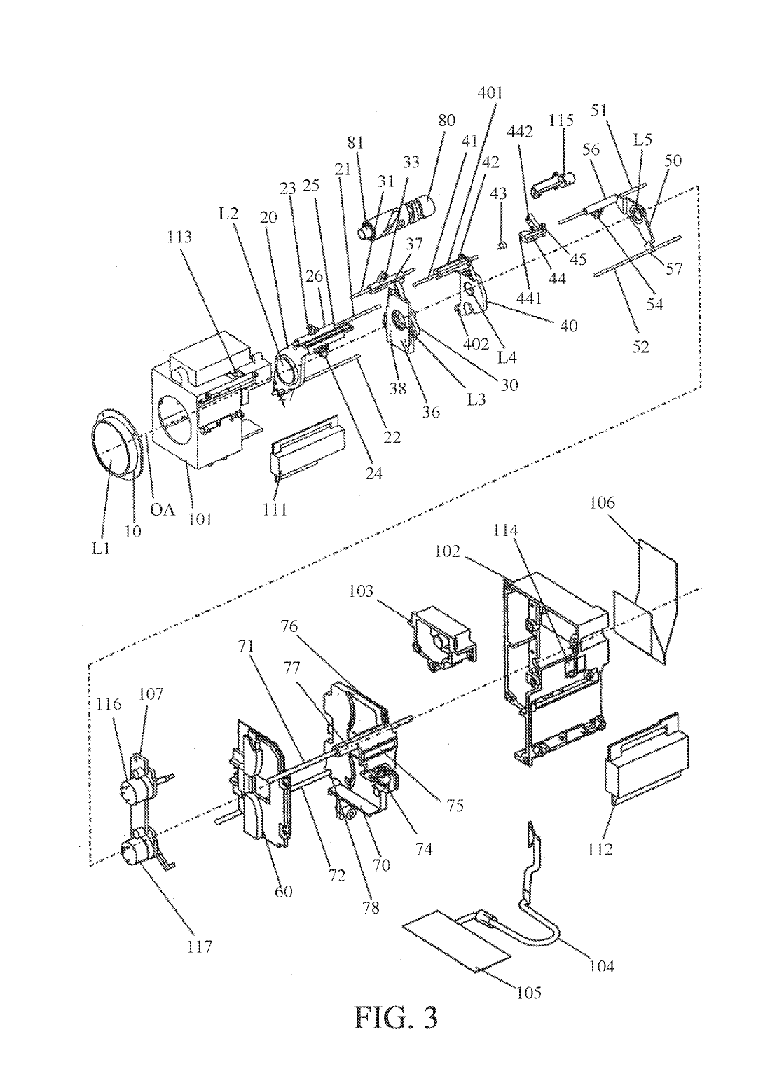

Referring now to FIGS. 1 to 3, a description will be given of a structure of an imaging apparatus according to this embodiment. FIG. 1 is a perspective view of the imaging apparatus 1 according to this embodiment. FIG. 2 is a sectional view of the imaging apparatus 1. FIG. 3 is an exploded perspective view of the imaging apparatus 1.

The imaging apparatus includes, in order from an object side to an image side, a first lens unit L1, a second lens unit L2, a third lens unit L3, a fourth lens unit L4, and a fifth lens unit L5. The first lens unit L1 to the fifth lens unit L5 constitute an imaging optical system. The imaging apparatus 1 includes a lens barrel that includes the imaging optical system and an image sensor IS, which will be described later. The first lens unit L1 is fixed in a direction along an optical axis OA (optical axis direction). The second lens unit L2, the third lens unit L3, and the fourth lens unit L4 move in the optical axis direction for a magnification varying operation (zooming). The fifth lens unit L5 moves in the optical axis direction for focusing. An optical filter OF includes, for example, an IR cut filter and a band-pass filter, and moves in a direction orthogonal to the optical axis OA (optical axis direction) or is inserted into and ejected from the optical path so as to transmit or shield light in a specific wavelength range. The image sensor IS includes a photoelectric conversion element, such as a CCD sensor and a CMOS sensor, and photoelectrically converts an optical image formed by the imaging optical system.

A first barrel 10 holds the first lens unit L1. A second barrel 20 (second lens holding frame) holds the second lens unit L2. A sleeve part 26 provided to the second barrel 20 is engaged with a guide bar 21, and thereby the second barrel 20 is guided in the optical axis direction. A U-shaped groove 27 provided in the second barrel 20 is engaged with a guide bar 22 (second guide bar), and thereby the second barrel 20 is restricted from rotating around the guide bar 21. A cam follower 23 (third cam follower) is rotatably attached to the second barrel 20. A rack member 24 is attached to the second barrel 20 rotatably on a plane orthogonal to the optical axis OA. A position detecting scale (scaler) 25 is fixed onto the second barrel 20.

A third barrel 30 holds the third lens unit L3. A sleeve part 37 provided to the third barrel 30 is engaged with a guide bar 31 (third guide bar), and thereby the third barrel 30 is guided in the optical axis direction. A U-shaped groove 38 provided in the third barrel 30 is engaged with the guide bar 22, and thereby the third barrel 30 is restricted from rotating around the guide bar 31. The cam follower 33 is rotatably attached to the third barrel 30. A diaphragm (stop) unit 36 is fixed onto the third barrel 30, and drives a diaphragm blade so as to change an aperture diameter.

A fourth barrel 40 (lens holding frame) holds the fourth lens unit L4. A sleeve part 401 (first sleeve) provided to the fourth barrel 40 is engaged with a guide bar 41, and thereby the fourth barrel 40 is guided in the optical axis direction. A U-shaped groove 402 (first U-shaped groove) provided in the fourth barrel 40 is engaged with a guide bar 22, and thereby the fourth barrel 40 is restricted from rotating around the guide bar 41. A cam follower 42 (first cam follower) is rotatably attached to the fourth barrel 40. A sleeve part 441 (second sleeve) provided to the moving member 44 is engaged with the guide bar 41, and thereby the moving member 44 is guided in the optical axis direction. When the U-shaped groove 442 (second U-shaped groove) provided in the moving member 44 is engaged with the guide bar 31, the moving member 44 is restricted from rotating around the guide bar 41. The cam follower 45 (second cam follower) is rotatably attached to the moving member 44. The forcing member 43 applies a force to the fourth barrel 40 and the moving member 44 in their separating directions.

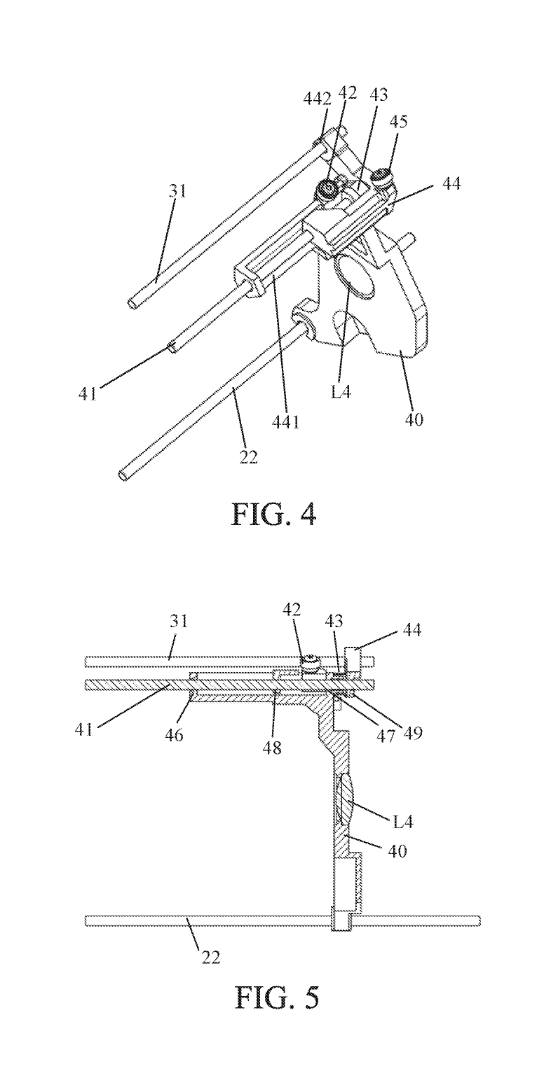

Referring now to FIGS. 4 and 5, a description will be given of the structures of the fourth barrel 40, the moving member 44, and the forcing member 43. FIG. 4 is a perspective view of the fourth barrel 40, the moving member 44, and the forcing member 43. FIG. 5 is a sectional view of the fourth barrel 40, the moving member 44, and the forcing member 43. The forcing member 43 is disposed coaxially with the guide bar 41 between the fourth barrel 40 and the moving member 44. The forcing member 43 is a compression torsion spring, and applies a force to the fourth barrel 40 and the moving member 44 so as to separate them from each other, and forces the U-shaped groove 442 in the moving member 44 against the guide bar 31. However, this embodiment is not limited to this example, and the forcing member 43 may be configured to apply a force to the fourth barrel 40 and the moving member 44 so as to attract them to each other. The fourth barrel 40 includes two engagement parts, i.e., an object side engagement part 46 (first engagement part) and an image plane side engagement part 47 (second engagement part) engaged with the guide bar 41. The moving member 44 includes two engagement parts, i.e., an object side engagement part 48 (third engagement part) and an image plane side engagement part 49 (fourth engagement part) engaged with the guide bar 41. The object side engagement part 46 and the image plane engagement part 47 in the fourth barrel 40 are engaged with the guide bar 41 so as to sandwich the object side engagement part 48 in the moving member 44. In other words, the third engagement part is provided between the first engagement part and the second engagement part.

In FIG. 3, a fifth barrel 50 holds the fifth lens unit L5. A sleeve part 56 provided to the fifth barrel 50 is engaged with a guide bar 51, and thereby the fifth barrel 50 is guided in the optical axis direction. A U-shaped groove 57 provided in the fifth barrel 50 is engaged with a guide bar 52, and thereby the fifth barrel 50 is restricted from rotating around the guide bar 51. A rack member 54 is rotatably attached to the fifth barrel 50.

An optical filter holding frame 60 holds an optical filter OF. An image sensor holding frame 70 holds the image sensor IS. The optical filter holding frame 60 is fixed onto the image sensor holding frame 70. A sensor substrate 76 fixes the image sensor IS, and is attached to the image sensor holding frame 70. A sleeve part 77 provided to the image sensor holding frame 70 is engaged with a guide bar 71, and thereby the image sensor holding frame 70 is guided in the optical axis direction. A U-shaped groove 78 provided in the image sensor holding frame 70 is engaged with a guide bar 72, and thereby the image sensor holding frame 70 is restricted from rotating around the guide bar 71. A rack member 74 is attached to the image sensor holding frame 70 rotatably on the plane orthogonal to the optical axis. A position detecting scale 75 is fixed onto the image sensor holding frame 70.

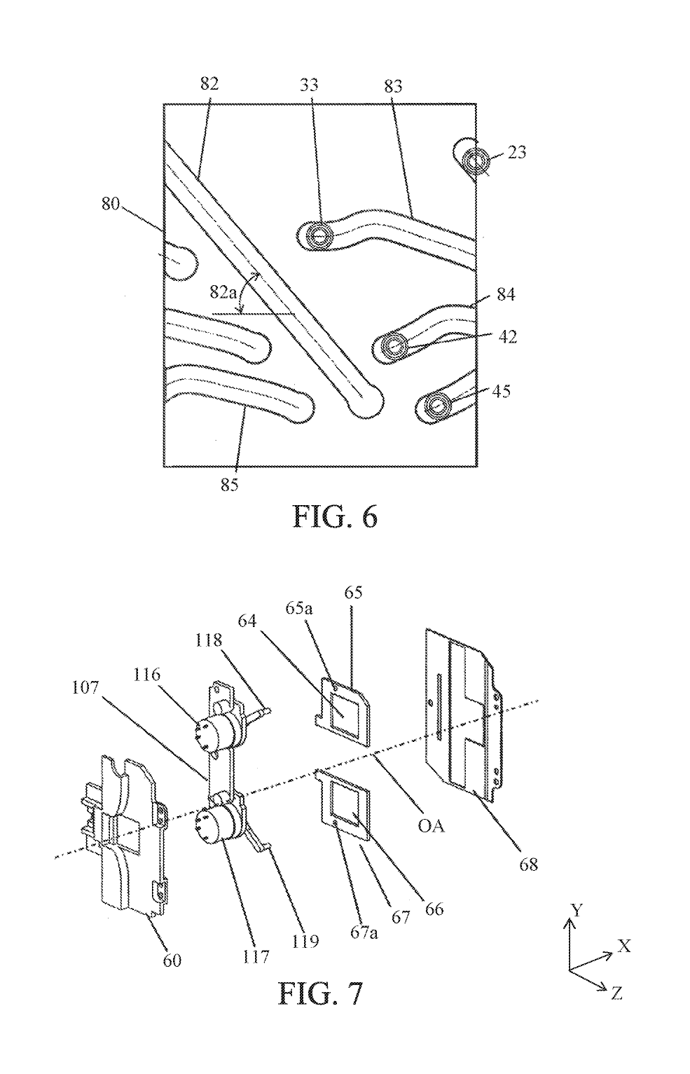

A cam cylinder 80 is rotatable around an axis parallel to the optical axis OA in the imaging optical system (first lens unit L1 to fifth lens unit L5), and has cam grooves 82 to 85. Referring now to FIG. 6, a description will be given of the cam grooves 82 to 85 in the cam cylinder 80. FIG. 6 is a developed view of the cam grooves 82 to 85. The cam groove 82 (third cam groove) is engaged with the cam follower 23 in the second barrel 20. The cam groove 83 is engaged with the cam follower 33 in the third barrel 30. The cam groove 84 (first cam groove) engaged with the cam follower 42 in the fourth barrel 40. The cam groove 85 (second cam groove) is engaged with the cam follower 45 in the moving member 44, and has almost the same shape as that of the cam groove 84. Herein, “almost the same” covers a shape that is evaluated to be a substantially the same shape as well as a strictly equal shape. As described later, the cam grooves 84 and 85 may be formed so as to cancel the rotating forces T₁ and T₂ of the cam cylinder 80 caused by the force F applied by the forcing member 43.

In FIG. 3, the first barrel 10, a guide holding member 103, and a motor holding member 107 used to insert and eject the optical filter OF are fixed into a front barrel 101. The guide bars 21, 22, 51, 52, 71, and 72 are sandwiched between the front barrel 101 and the rear barrel 102. The guide bars 31 and 41 are sandwiched between the front barrel 101 and the guide holding member 103. The cam cylinder forcing member 81 forces the cam cylinder 80 in the optical axis direction. The cam cylinder 80 is rotatably sandwiched between the front barrel 101 and the rear barrel 102 via a cam cylinder forcing member 81.

An optical sensor 113 is fixed onto the front barrel 101, and an optical sensor 114 is fixed onto the rear barrel 102. The optical sensors 113 and 114 have a light emitter and a light receiver, detect light of a periodic bright-and-dark pattern reflected on position detecting scales 25 and 75 attached to the second barrel 20 and the image sensor holding frame 70, and converts the light into an electric signal. Thereby, the optical sensors 113 and 114 detect positions of the second barrel 20 and the image sensor holding frame 70.

Each of Oscillation type linear actuators 111 and 112 serves as a driver that includes the unillustrated slider and oscillator. When a frequency signal is input to the oscillator via the unillustrated flexible printed substrate, the oscillator generates an approximately elliptic motion so as to generate a driving force on a press surface with a slider. An oscillation type linear actuator (linear oscillation actuator) 111 is fixed onto the front barrel 101 and engaged with the rack member 24. When the oscillation type linear actuator 111 generates a driving force in the optical axis direction, the second barrel 20 moves back and forth in the optical axis direction via the rack member 24. When the second barrel 20 moves back and forth in the optical axis direction, the cam cylinder 80 engaged with the cam follower 23 in the second barrel 20 rotates on the plane orthogonal to the optical axis. As the cam cylinder 80 rotates on the plane orthogonal to the optical axis, the third barrel 30, the fourth barrel 40, and the moving member 44 move back and forth in the optical axis direction via the cam followers 33, 42, and 45 engaged with the cam cylinder 80. According to this embodiment, the cam groove 84 engaged with the cam follower 42 in the fourth barrel 40 and the cam groove 85 engaged with the cam follower 45 in the moving member 44 have almost the same shape. Hence, the fourth barrel 40 and the moving member 44 move back and forth in the optical axis direction with almost the same locus.

The oscillation type linear actuator 112 is fixed onto the rear barrel 102, and engaged with the rack member 74. When the oscillation type linear actuator 112 generates a driving force in the optical axis direction, the image sensor holding frame 70 moves back and forth in the optical axis direction via the rack member 74. The second barrel 20, the third barrel 30, the fourth barrel 40, the moving member 44, and the image sensor holding frame 70 move back and forth in the optical axis direction for a magnification varying operation (zooming) by driving the oscillation type linear actuators 111 and 112. The stepping motor 115 is fixed onto the front barrel 101, and engaged with the rack member 54. When the driving force occurs in the stepping motor 115 in the optical axis direction, the fifth barrel 50 moves back and forth in the optical axis direction via the rack member 54 for focusing.

Optical filter insertion/ejection motors 116 and 117 are fixed onto the motor holding member 107. Referring now to FIG. 7, a description will be given of the optical filter driving mechanism that include the optical filter insertion/ejection motors 116 and 117. FIG. 7 is an exploded perspective view of the optical filter driving mechanism. An IR cut filter 64 has an optical characteristic that filters the infrared light. The filter holding frame 65 holds the IR cut filter 64. The band-pass filter 66 has an optical characteristic that transmits light in a specific wavelength range. A filter holding frame 67 holds the band-pass filter 66. The filter holding fames 65 and 67 are movably held between a cover member 68 and the optical filter holding frame 60 on the plane orthogonal to the optical axis OA. Engagement arms 118 and 119 are engaged with the optical filter insertion/ejection motors 116 and 117. The engagement arms 118 and 119 are engaged with engagement holes 65a and 67a in the filter holding frames 65 and 67.

As the optical filter insertion/ejection motors 116 and 117 rotate around an axis parallel to the optical axis OA, the engagement arms 118 and 119 rotate and the filter holding frames 65 and 67 move in the Y-axis direction in FIG. 7. When the filter holding frame 65 is inserted into the optical path, the infrared light is filtered from the light incident on the image sensor IS and light suitable for the normal colored image can be obtained. When the filter holding frame 67 is inserted into the optical path, light only in the specific wavelength range, such as near infrared light, enters the image sensor IS, and the light suitable for a high-contrast image can be obtained. When the filter holding frames 65 and 67 are retreated from the optical path, the light that contains infrared light enters the image sensor IS and a larger light amount can be obtained so as to capture an image under the low luminance, such as at night.

In FIG. 3, an electric wire 104 inputs and outputs an electric signal to and from the image sensor IS. A lens substrate 105 is fixed onto the front barrel 101. The lens substrate 105 inputs and outputs an electric signal to and from a variety of sensors, such as the oscillation type linear actuators 111 and 112, the stepping motor 115, the optical filter insertion/ejection motors 116 and 117, and the optical sensors 113 and 114, via the unillustrated flexible printed substrate. One end of the electric wire 104 is connected to the sensor substrate 76, and the other end is connected to the lens substrate 105. Both ends of the electric wire 104 are fixed in a U-shaped bending state, and even when the image sensor holding frame 70 moves in the optical axis direction, a curvature is formed which prevents the thrust of the oscillation type linear actuator 112 necessary to move the image sensor holding frame 70 from excessively increasing.

A thermal conductive member 106 is a flexible sheet member having a high thermal conductivity, such as a graphite sheet. One end of the thermal conductive member 106 is fixed onto a sensor substrate 76, and the other end thereof is fixed onto an unillustrated heat sink. When the heat generated in the sensor substrate 76 is transferred to the heat sink, the temperature rise of the image sensor IS can be restrained. The thermal conductive member 106 is folded in a bellows shape along the optical axis at the backside of the image sensor holding frame 70 so as to prevent the thrust of the oscillation type linear actuator 112 necessary to move the image sensor holding frame 70 from excessively increasing even when the image sensor holding frame 70 is moved in the optical axis direction.

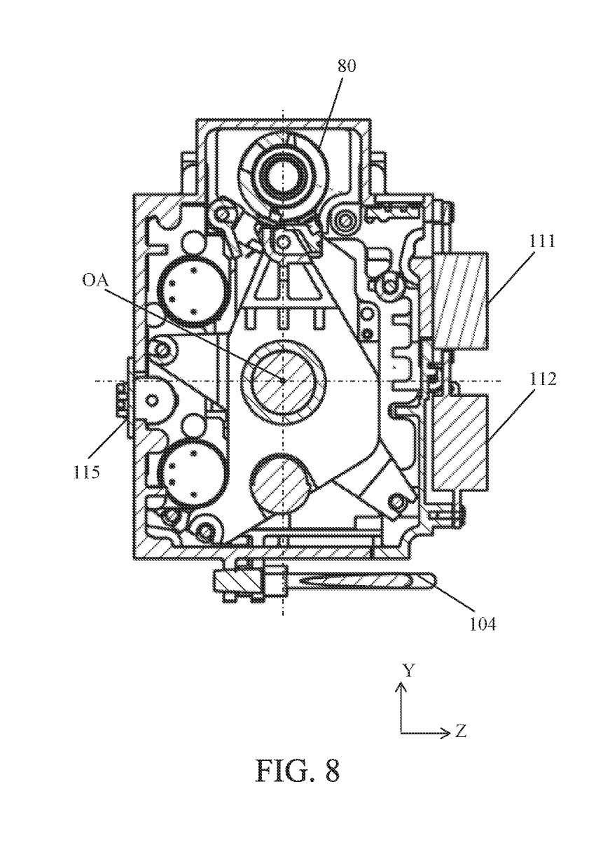

Referring now to FIG. 8, a description will be given of an arrangement of the components in the imaging apparatus 1. FIG. 8 is a sectional view viewed from the front side of the imaging apparatus 1 by severing it with a plane perpendicular to the optical axis OA in the imaging apparatus 1. The cam cylinder 80 is disposed on a side surface of the imaging apparatus in the +Y direction relative to the optical axis OA. The oscillation type linear actuators 111 and 112 are arranged on side surfaces of the imaging apparatus 1 in the +Z direction. A stepping motor 115 is disposed on the side surface of the imaging apparatus 1 in the direction. The electric wire 104 is disposed on the side surface of the imaging apparatus 1 in the −Y direction, and bent on the plane approximately parallel to the XZ plane.

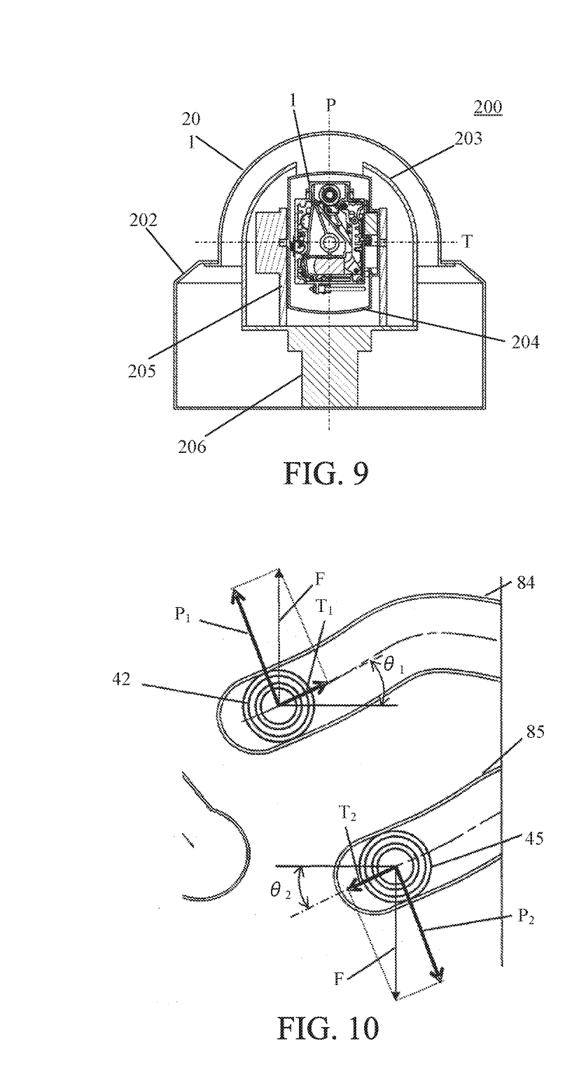

Referring now to FIG. 9, a description will be given of a surveillance camera 200 that includes the imaging apparatus 1. FIG. 9 is a sectional view of the surveillance camera 200 severed with a plane perpendicular to the optical axis OA. The imaging apparatus 1 is covered with a dome 201 (housing) and supported rotatably around a pan axis P and a tilt axis T. The dome 201 is a transparent or semitransparent plastic cover member. Reference numeral 202 denotes a case, and reference numeral 203 denotes an inner cover. The camera case 204 houses the imaging apparatus 1. A tilt unit 205 supports the camera case 204 rotatably around the tilt axis T. The tilt unit 205 has a tilt driver that includes an unillustrated stepping motor etc., and electrically drives the camera case 204 in the tilt direction. A pan unit 206 supports the tilt unit 205 around the pan axis P. The pan unit 206 includes a pan driver includes an unillustrated stepping motor, etc., and electrically drives the tilt unit 205 in the pan direction.

Referring now to FIG. 10, a description will be given of the force applied by the forcing member 43. FIG. 10 schematically illustrates a direction of the force applied by the forcing member 43. The force F applied by the forcing member 43 applies to the cam follower 42 a contact force P₁ that brings the cam follower 42 into contact with the cam groove 84 and a rotating force T₁ that rotates the cam cylinder 80. The force applied by the forcing member 43 applies to the cam follower 45 a contact force P₂ that brings the cam follower 45 into contact with the cam groove 85 and a rotating force T₂ that rotates the cam cylinder 80.

In this embodiment, the cam grooves 84 and 85 have almost the same shapes, and thus a relationship of θ₁=θ₂ is substantially established where θ₁ is a cam intersection angle about the fourth barrel 40 (cam groove 84) and θ₂ is a cam intersection angle about the moving member 44 (cam groove 85). Herein, that the relationship of θ₁=θ₂ is substantially established means, for example, that 0.8≤θ₁/θ₂≤1.2 is satisfied in addition to the strict establishment of the relationship θ₁=θ₂. The rotating forces T₁ and T₂ satisfy T₁=F cos θ₁ and T₂=F cos θ₂. Since this embodiment satisfies θ₁=θ₂, a relationship of T₁=T₂ is satisfied. Since each of the rotating forces T₁ and T₂ rotates the cam cylinder 80 in the reverse direction and T₁=T₂ is satisfied, these forces are cancelled out and do not serve as a rotating force to rotate the cam cylinder 80. Hence, the backlash of the fourth barrel 40 in the optical axis direction can be reduced or removed without increasing the torque necessary to rotate the cam cylinder 80. The structure of this embodiment reduces (removes) the backlash and can improve the stopping accuracy in moving the fourth barrel 40 back and fourth in the optical axis direction.

As illustrated in FIG. 6, the cam groove 82 has an approximately linear shape, and a cam intersection angle 82a about the cam groove 82 has an approximately constant value of about 50°. The thrust of the oscillation type linear actuator ill can be effectively converted into the rotating force of the cam cylinder 80 by making the cam intersection angle 82a relatively large and approximately constant.

Thus, this embodiment does not increase the torque necessary to rotate the cam cylinder 80 caused by the force applied by the forcing member 43 or cause the driver for driving the cam cylinder 80 to be larger or reduce the speed with a gear etc. Hence, the imaging lens can have a high performance without using a large dome housing etc. As a result, this embodiment can provide a small and high-performance lens barrel and an imaging apparatus having the same.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-161710, filed on Aug. 25, 2017, which is hereby incorporated by reference herein in its entirety.

What is claimed is:

1. A lens barrel comprising:
a cam cylinder rotatable around an axis parallel to an optical axis in a lens unit, the cam cylinder having a first cam groove and a second cam groove;
a lens holding frame that includes a first cam follower engaged with the first cam groove;
a moving member that includes a second cam follower engaged with the second cam groove; and
a forcing member configured to apply a force to the first lens holding frame and the moving member in directions different from each other in an optical axis direction,
wherein the first cam groove and the second cam groove are formed so as to cancel out a rotating force of the cam cylinder caused by the force applied by the forcing member.

2. The lens barrel according to claim 1, wherein 0.8≤θ₁/θ₂≤1.2 is satisfied where θ₁ is a cam intersection angle about the first cam groove, and θ₂ is a cam intersection angle about the second cam groove.

3. The lens barrel according to clan 1, wherein the first cam groove and the second cam groove have the same shape.

4. The lens barrel according to claim 1, wherein the lens holding frame and the moving member move back and forth in the optical axis direction with the same locus.

5. The lens barrel according to claim 1, wherein the forcing member applies the force so that the lens holding frame and the moving member separate from or attract to each other in the optical axis direction.

6. The lens barrel according to claim 1, further comprising a first guide bar held parallel to the optical axis,
wherein the lens holding frame includes a first sleeve movably engaged with the first guide bar, and
wherein the moving member includes a second sleeve movably engaged with the first guide bar.

7. The lens barrel according to claim 1, wherein the lens holding frame includes a first engagement part and a second engagement part that are engaged with the first guide bar,
wherein the moving member includes a third engagement part and a fourth engagement part that are engaged with the first guide bar, and
wherein the third engagement part is provided between the first engagement part and the second engagement part.

8. The lens barrel according to claim 6, further comprising a second guide bar and a third guide bar held that are parallel to the optical axis,
wherein the lens holding frame has a first U-shaped groove engaged with the second guide bar, and
wherein the moving member has a second U-shaped groove engaged with the third guide bar.

9. The lens barrel according to claim 1, further comprising:
a second lens holding frame that includes a third cam follower; and
a driver configured to move the second lens holding frame back and forth in the optical axis direction,
wherein as the second lens holding frame moves hack and forth in the optical axis direction, the cam cylinder rotates and the lens holding frame and the moving member move back and forth in the optical axis direction.

10. The lens barrel according to claim 9, wherein the cam cylinder has a third cam groove engaged with the third cam follower, and
wherein the third cam groove forms a constant cam intersection angle.

11. The lens barrel according to claim 9, wherein the driver is an oscillation type linear actuator.

12. An imaging apparatus comprising a lens barrel, and an image sensor configured to photoelectrically convert an optical image formed by the lens barrel,
wherein the lens barrel includes:
a cam cylinder rotatable around an axis parallel to an optical axis in a lens unit, the cam cylinder having a first cam groove and a second cam groove;
a lens holding frame that includes a first cam follower engaged with the first cam groove;
a moving member that includes a second cam follower engaged with the second cam groove; and
a forcing member configured to apply a force to the first lens holding frame and the moving member in directions different from each other in an optical axis direction,
wherein the first cam groove and the second cam groove are formed so as to cancel out a rotating force of the cam cylinder caused by the force applied by the forcing member.
